(19) United States
(12) Patent Application Publication
(10) Pub. No.: US 2010/0126135 A1
(43) Pub. Date: May 27, 2010

(54) METHOD AND APPARATUS FOR OPERATING AN INTEGRATED GASIFIER POWER PLANT

(75) Inventors: Narendra Digamber Joshi, Schenectady, NY (US); Jamison W. Janawitz, Overland Park, KS (US)

Correspondence Address: GE Energy-Global Patent Operation;Fletcher Yoder PC, P.O. Box 692289, Houston, TX, 77269-2289, US

(73) Assignee: GENERAL ELECTRIC COMPANY, Schenectady, NY (US)

(21) Appl. No.: 12/324,722

(22) Filed: Nov. 26, 2008

(51) Int. Cl. F02C 3/20; F02B 43/08

(52) U.S. Cl. 60/39.12; 60/781

(57) ABSTRACT

In one embodiment, a method includes converting a hydrocarbon feedstock into a gas mixture. The method also includes burning a first portion of the gas mixture within a combustion chamber. The method further includes converting a second portion of the gas mixture into methanol during periods of low demand for the gas mixture within the combustion chamber.

### BACKGROUND OF THE INVENTION

The subject matter disclosed herein relates to integrated gasification combined cycle (IGCC) power generation systems and, more specifically, to IGCC power generation systems with load-following capabilities.

In general, IGCC power plants are capable of generating energy from various hydrocarbon feedstock, such as coal, relatively cleanly and efficiently. IGCC technology may convert the hydrocarbon feedstock into a gas mixture of carbon monoxide (CO) and hydrogen (H₂) by reaction with steam. These gases may be cleaned, processed, and utilized as fuel in a conventional combined cycle power plant. Coal gasification processes may utilize compressed air or oxygen to react with the coal to form the CO and H₂. These processes may generally take place at relatively high pressures and temperatures and may generally be more efficient at design point conditions. As such, the coal gasification processes cannot be turned down without loss of efficiency and durability. As a result, an IGCC power plant utilizing coal cannot easily follow grid loads during periods of low demand. Rather, during periods of low demand, shutdowns and reduced power generation from the IGCC power plant, as well as other plants, may be required.

### BRIEF DESCRIPTION OF THE INVENTION

In one embodiment, a method includes converting a hydrocarbon feedstock into a gas mixture. The method also includes burning a first portion of the gas mixture within a combustion chamber. The method further includes converting a second portion of the gas mixture into methanol during periods of low demand for the gas mixture within the combustion chamber.

In another embodiment, a combined cycle power generation system is provided. The system includes a gasifier configured to convert coal into a gas mixture. The system also includes a combined cycle gas turbine configured to receive and burn a first portion of the gas mixture as a fuel source. The system further includes a methanol plant configured to receive and convert a second portion of the gas mixture into methanol during periods of low demand for the combined cycle gas turbine.

In yet another embodiment, a methanol generation and storage system is provided. The system includes a methanol plant configured to receive a variable portion of a gas mixture from a gasifier and to convert the variable portion of the gas mixture into methanol. The system also includes a storage tank configured to store the methanol and to deliver the methanol for subsequent use as a fuel source.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic flow diagram of an embodiment of a combined cycle power generation system having a gas turbine, a steam turbine, and a heat recovery steam generation system;

FIG. 2 is a schematic flow diagram of an embodiment of a coal gasification process of an IGCC power generation system;

FIG. 3 is a chart of daily variation of grid loads experienced by an embodiment of the coal gasification process of FIG. 2;

FIG. 4 is a schematic flow diagram of an embodiment of a coal gasification process of an IGCC power generation system, including a methanol plant and associated storage tanks;

FIG. 5 is a chart of daily variation of grid loads experienced by an embodiment of the coal gasification process of FIG. 4; and

FIG. 6 is a flow chart of an embodiment of a method for producing and storing methanol for use in an IGCC power generation system.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

In certain embodiments, the systems and methods described herein include integrating a methanol plant into an IGCC power generation system. A gas mixture produced by a gasification process of the IGCC power generation system may be converted into methanol. In particular, excess volumes of the gas mixture may be converted into methanol and stored in storage tanks. For instance, during periods of low power demand, excess volumes of the gas mixture not required by the IGCC power generation system may be converted into methanol and stored in the storage tanks. Then, during periods of high power demand, the power output of the IGCC power generation system may be supplemented by a peaking cycle power generation system utilizing at least some of the methanol stored in the storage tanks as a fuel source. By more efficiently utilizing the gas mixture produced by the gasification process, the IGCC power generation system may become both more flexible and more self-sustainable. Moreover, the gasifier units used in the gasification process may be reduced in size, leading to overall cost reductions. In addition, by running the gasifier units at a more constant production rate, operating costs as well as long-term damage to the gasifier may be minimized.

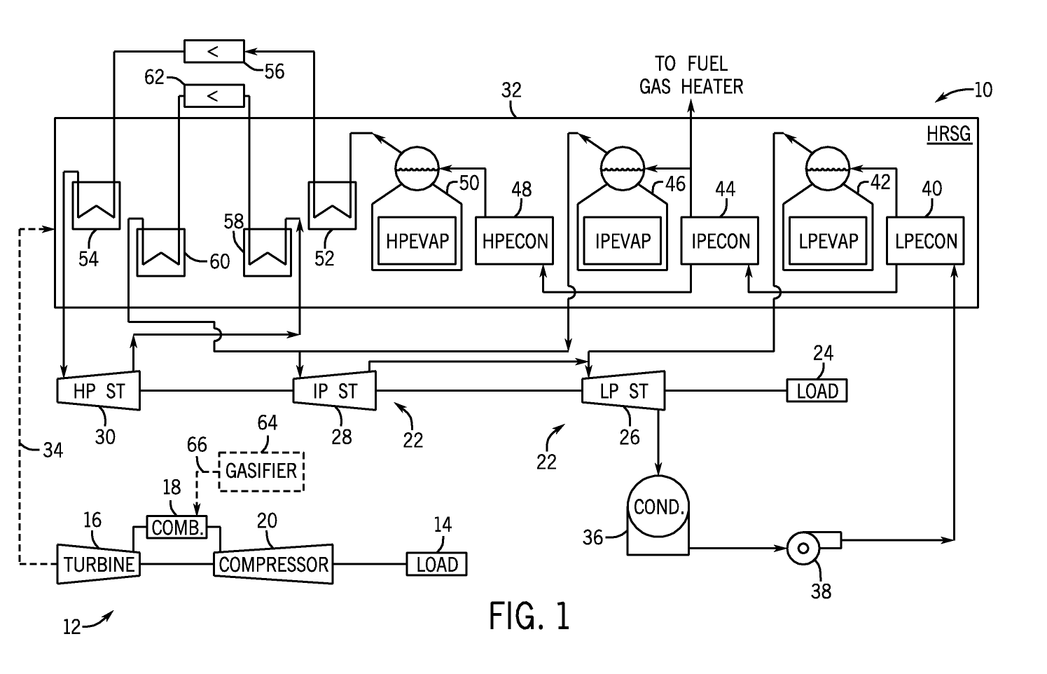

FIG. 1 is a schematic flow diagram of an embodiment of a combined cycle power generation system 10 having a gas turbine, a steam turbine, and a heat recovery steam generation (HRSG) system. The system 10 may include a gas turbine 12 for driving a first load 14. The first load 14 may, for instance, be an electrical generator for producing electrical power. The gas turbine 12 may include a turbine 16, a combustor or combustion chamber 18, and a compressor 20. The system 10 may also include a steam turbine 22 for driving a second load 24. The second load 24 may also be an electrical generator for generating electrical power. However, both the first and second loads 14, 24 may be other types of loads capable of being driven by the gas turbine 12 and steam turbine 22. In addition, although the gas turbine 12 and steam turbine 22 may drive separate loads 14 and 24, as shown in the illustrated embodiment, the gas turbine 12 and steam turbine 22 may also be utilized in tandem to drive a single load via a single shaft. In the illustrated embodiment, the steam turbine 22 may include one low-pressure section 26 (LP ST), one intermediate-pressure section 28 (IP ST), and one high-pressure section 30 (HP ST). However, the specific configuration of the steam turbine 22, as well as the gas turbine 12, may be implementation-specific and may include any combination of sections.

The system 10 may also include a multi-stage HRSG 32. The components of the HRSG 32 in the illustrated embodiment are a simplified depiction of the HRSG 32 and are not intended to be limiting. Rather, the illustrated HRSG 32 is shown to convey the general operation of such HRSG systems. Heated exhaust gas 34 from the gas turbine 12 may be transported into the HRSG 32 and used to heat steam used to power the steam turbine 22. Exhaust from the low-pressure section 26 of the steam turbine 22 may be directed into a condenser 36. Condensate from the condenser 36 may, in turn, be directed into a low-pressure section of the HRSG 32 with the aid of a condensate pump 38.

The condensate may then flow through a low-pressure economizer 40 (LPECON), a device configured to heat feedwater with gases, which may be used to heat the condensate. From the low-pressure economizer 40, the condensate may either be directed into a low-pressure evaporator 42 (LPEVAP) or toward an intermediate-pressure economizer 44 (IPECON). Steam from the low-pressure evaporator 42 may be returned to the low-pressure section 26 of the steam turbine 22. Likewise, from the intermediate-pressure economizer 44, the condensate may either be directed into an intermediate-pressure evaporator 46 (IPEVAP) or toward a high-pressure economizer 48 (HPECON). In addition, steam from the intermediate-pressure economizer 44 may be sent to a fuel gas heater (not shown) where the steam may be used to heat fuel gas for use in the combustion chamber 18 of the gas turbine 12. Steam from the intermediate-pressure evaporator 46 may be sent to the intermediate-pressure section 28 of the steam turbine 22. Again, the connections between the economizers, evaporators, and the steam turbine 22 may vary across implementations as the illustrated embodiment is merely illustrative of the general operation of an HRSG system that may employ unique aspects of the present embodiments.

Finally, condensate from the high-pressure economizer 48 may be directed into a high-pressure evaporator 50 (HPEVAP). Steam exiting the high-pressure evaporator 50 may be directed into a primary high-pressure superheater 52 and a finishing high-pressure superheater 54, where the steam is superheated and eventually sent to the high-pressure section 30 of the steam turbine 22. Exhaust from the high-pressure section 30 of the steam turbine 22 may, in turn, be directed into the intermediate-pressure section 28 of the steam turbine 22. Exhaust from the intermediate-pressure section 28 of the steam turbine 22 may be directed into the low-pressure section 26 of the steam turbine 22.

An inter-stage attemperator 56 may be located in between the primary high-pressure superheater 52 and the finishing high-pressure superheater 54. The inter-stage attemperator 56 may allow for more robust control of the exhaust temperature of steam from the finishing high-pressure superheater 54. Specifically, the inter-stage attemperator 56 may be configured to control the temperature of steam exiting the finishing high-pressure superheater 54 by injecting cooler feedwater spray into the superheated steam upstream of the finishing high-pressure superheater 54 whenever the exhaust temperature of the steam exiting the finishing high-pressure superheater 54 exceeds a predetermined value.

In addition, exhaust from the high-pressure section 30 of the steam turbine 22 may be directed into a primary re-heater 58 and a secondary re-heater 60 where it may be re-heated before being directed into the intermediate-pressure section 28 of the steam turbine 22. The primary re-heater 58 and secondary re-heater 60 may also be associated with an inter-stage attemperator 62 for controlling the exhaust steam temperature from the re-heaters. Specifically, the inter-stage attemperator 62 may be configured to control the temperature of steam exiting the secondary re-heater 60 by injecting cooler feedwater spray into the superheated steam upstream of the secondary re-heater 60 whenever the exhaust temperature of the steam exiting the secondary re-heater 60 exceeds a predetermined value.

In combined cycle systems such as system 10, hot exhaust gas 34 may flow from the gas turbine 12 and pass through the HRSG 32 and may be used to generate high-pressure, high-temperature steam. The steam produced by the HRSG 32 may then be passed through the steam turbine 22 for power generation. In addition, the produced steam may also be supplied to any other processes where superheated steam may be used. The gas turbine 12 cycle is often referred to as the “topping cycle,” whereas the steam turbine 22 generation cycle is often referred to as the “bottoming cycle.” By combining these two cycles as illustrated in FIG. 1, the combined cycle power generation system 10 may lead to greater efficiencies in both cycles. In particular, exhaust heat from the topping cycle may be captured and used to generate steam for use in the bottoming cycle.

The combined cycle power generation system 10 illustrated in FIG. 1 may be converted into an IGCC power generation system 10 by introducing a gasifier 64 into the system 10. In a coal gasification process, performed within the gasifier 64, rather than burning the coal, the gasifier 64 may break down the coal chemically due to the interaction with steam and the high pressure and temperature within the gasifier 64. From this process, the gasifier 64 may produce a gas mixture 66 of primarily CO and H₂. This gas mixture 66 is often referred to as “syngas” and may be burned, much like natural gas, within the combustion chamber 18 of the gas turbine 12. As will be described in greater detail below, the gas mixture 66 may also be converted into methanol, which may be burned within the combustion chamber 18 as well. In addition, at least some of the produced methanol may be stored within storage tanks for later use within either the combustion chamber 18 or other processes within or external to the combined cycle power generation system 10 of FIG. 1.

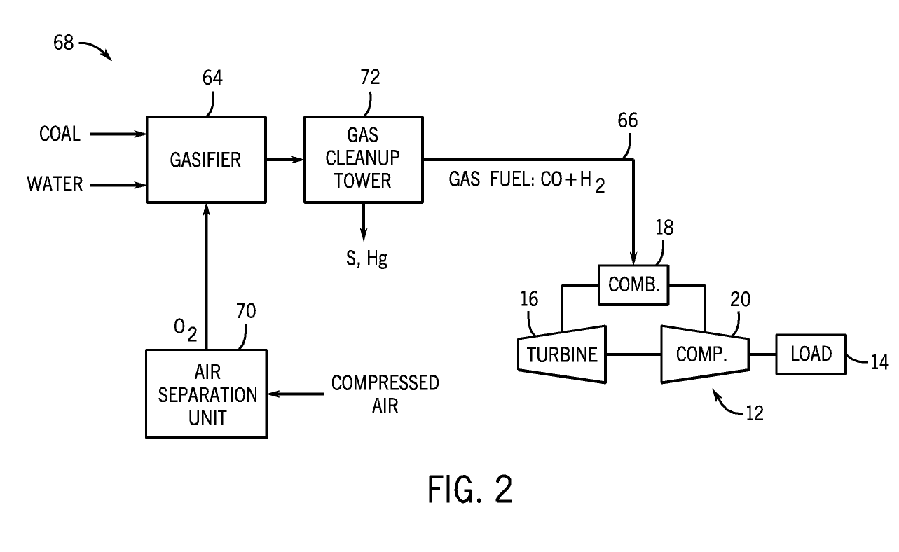

FIG. 2 is a schematic flow diagram of an embodiment of a coal gasification process 68 of an IGCC power generation system 10. As discussed above, the coal gasification process 68 may include the gasifier 64. The gasifier 64 may receive coal and water, such as steam, as inputs. Steam received by the gasifier may, for instance, be received from processes either within or external to the IGCC power generation system 10. For example, in certain embodiments, the steam may be received from the bottoming cycle of the IGCC power generation system 10, as illustrated in FIG. 1. However, the steam may also be received from various other processes within the IGCC power generation system 10 as well as from external sources.

The gasifier 64 may also receive high pressure oxygen (O₂) from an air separation unit 70. More specifically, the air separation unit 70 may receive compressed air and generate high pressure O₂ as an oxidant for use in the gasifier 64. The compressed air received by the air separation unit 70 may, for instance, be received from processes either within or external to the IGCC power generation system 10. For example, in certain embodiments, the compressed air may be received from the gas turbine compressor 20 of the gas turbine 12 of the IGCC power generation system 10. However, the compressed air may also be received from various other processes within the IGCC power generation system 10, as well as from external sources. In addition, in certain embodiments, nitrogen (N₂) generated by the air separation unit 70 may also be directed toward other processes, such as the gas turbine 12.

As discussed above, the coal received by the gasifier 64 may be reacted at high pressures and temperatures with the O₂ and steam to form a gas mixture of CO and H₂ as well as other components generated by the chemical reactions within the gasifier 64. These other components may include sulfur (S) and associated sulfides such as hydrogen sulfide and carbonyl sulfide, mercury (Hg), ammonia, slag, and other particulates. However, the primary components of the gas mixture produced by the gasifier 64 are CO and H₂. The gas mixture produced by the gasifier 64 may be sent to a gas cleanup tower 72, where the contaminants present in the gas mixture may be removed. For instance, the sulfur and associated sulfides, mercury, ammonia, slag, and other particulates may be removed, leaving only a substantially pure form of syngas (i.e., CO and H₂). The removal of contaminants may, for instance, include the use of scrubbers or dry filtration equipment for removing solid particulates, the use of solvents for removing the sulfides, and so forth. It should also be noted that, in certain embodiments, any carbon dioxide (CO₂) captured by the gas cleanup tower 72 may be sequestered.

The gas mixture produced by the gasifier 64 may have a very high temperature due to the high pressures and temperatures used in the chemical processes of the gasifier 64. Therefore, the gas cleanup tower 72 may also include a gas cooling unit, which may cool the hot gas mixture before removing the contaminants. The heat extracted from the hot gas mixture may be captured and used in other processes. In addition, the gas cleanup tower 72 may also include other various sub-systems for conditioning the gas mixture. In general, the gas cleanup tower 72 may ensure that the syngas generated by the gasifier 64 is characterized by appropriate temperatures, pressures, chemical compositions, stoichiometric parameters, and so forth, such that the syngas may be burned efficiently within the combustion chamber 18 of the gas turbine 12 of the IGCC power generation system 10.

Therefore, the gasifier 64, in association with the air separation unit 70 and the gas cleanup tower 72, may generate CO and H₂ which may be used as a fuel source to drive the generation of power within the topping cycle of the IGCC power generation system 10. However, as discussed above, one characteristic of gasifiers in general is that they operate at high pressures and temperatures and work most efficiently at design point conditions. Therefore, the gasifier 64 may not be capable of being operated at conditions other than design point conditions without loss of efficiency and durability. More specifically, the gasifier 64 may not be capable of being turned down (i.e., operating at lower outputs than a design point) during periods of low power demand.

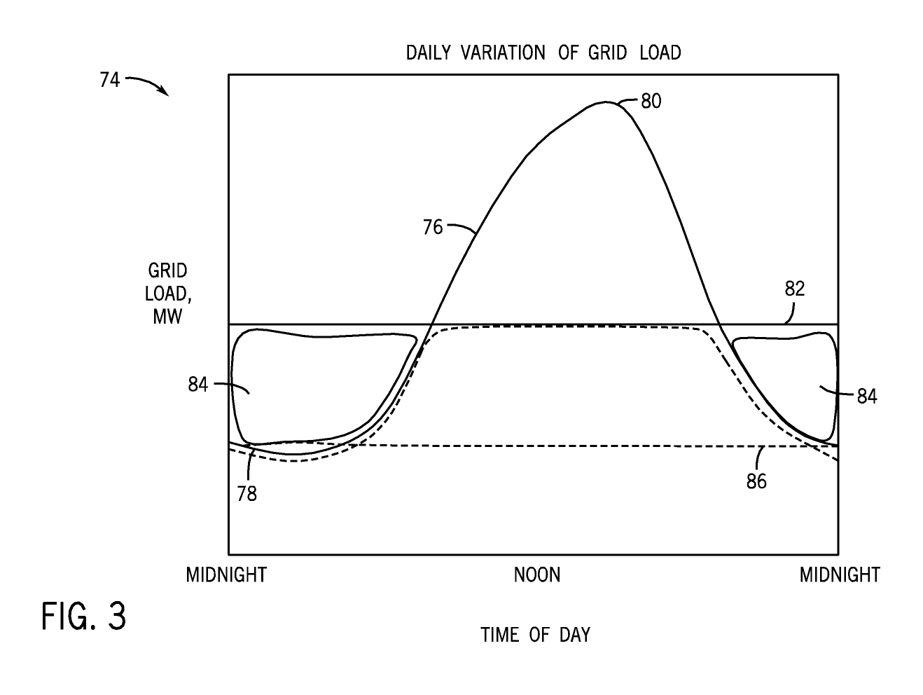

FIG. 3 is a chart 74 of daily variation of grid loads experienced by an embodiment of the coal gasification process 68 of FIG. 2. More specifically, the chart 74 depicts the daily variation of grid loads that may be demanded of the gas turbine 12 which may be fueled by CO and H₂ from the gasification process 68 of FIG. 2. As shown in FIG. 2, the grid load requirements 76 of the gas turbine 12 and, therefore, the gasification process 68 may change over the course of a day. Specifically, the grid load requirements 76 may increase from a low demand point 78, which may generally occur a few hours after midnight, to a peak load demand point 80, which may generally occur a few hours after noon.

The gasification process 68 may be designed to produce enough of the gas mixture such that the gas turbine 12 may meet an average daily load 82, which is somewhere between the low demand point 78 and the peak load demand point 80. However, operating the gasification process 68 at the average daily load 82 may, as mentioned above, be problematic in that the gasification process 68 may not easily be turned down during low demand periods. Therefore, during these low demand periods, the coal conversion capabilities of the gasification process 68 and, more specifically, the gasifier 64 may be underutilized, as indicated by regions 84. In particular, since the gasification process 68 may not be turned down during low demand periods, the power generated by the gas turbine 12 may simply be wasted during these low demand periods. Thus, it is desirable to convert gas fuel into methanol to facilitate storage during lower than average demand periods and burn methanol in the power plant during high demand periods, allowing for the use of an optimally sized gasifier 64.

Another option for sizing the gasification process 68 may be to ensure that the gasification process 68 may produce only enough of the gas mixture such that the gas turbine 12 may meet a base load 86, which corresponds to the grid load requirements 76 at the low demand point 78. However, under this design scenario, any excess power requirements would need to be met by other power generation sources, such as peak loading facilities. Moreover, designing the gasification process 68, as well as the IGCC power generation system 10 in general, at the lower base load may not allow for capturing economies of scale. Therefore, the first scenario discussed above, where the gasification process 68 is operated to produce enough of the gas mixture such that the gas turbine 12 may meet the average daily load 82 may be a better alternative. However, in order to fully utilize the capacity of the gasification process 68 and associated gasifier 64, the underutilization of coal during low demand periods and the shortage of power during peak loading periods may be addressed using the techniques described herein.

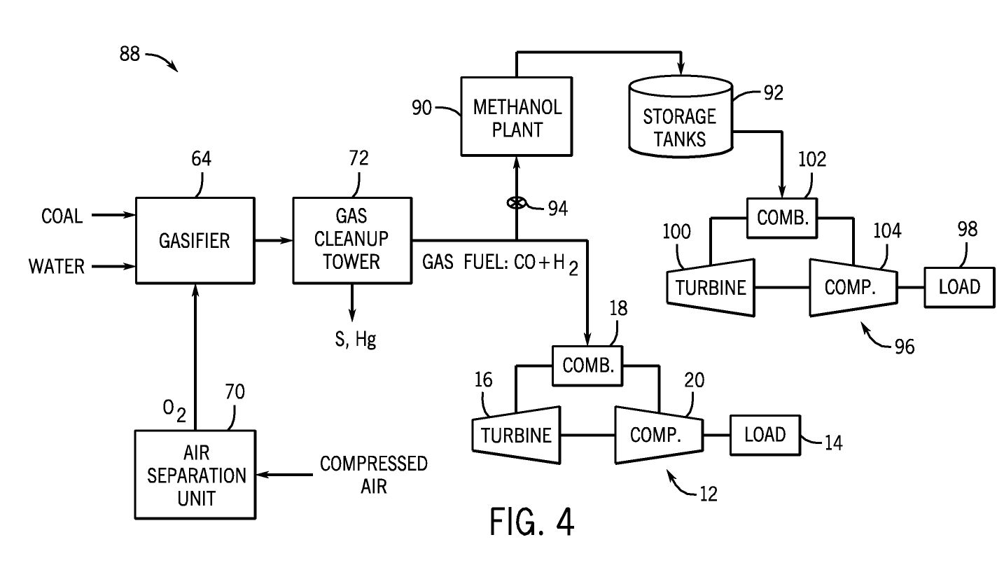

In particular, FIG. 4 is a schematic flow diagram of an embodiment of a coal gasification process 88 of an IGCC power generation system 10, including a methanol plant 90 and associated storage tanks 92. In general, the methanol plant 90 may be configured to convert the gas mixture of CO and H₂ into methanol (CH₃OH). Methanol is a liquid which is suitable for combustion within the combustion chamber 18 of the gas turbine 12. However, the storage density of methanol is considerably higher than that of the individual components CO and H₂. In other words, a given mass of methanol may require less volume than a similar mass of the individual components CO and H₂. For instance, the difference in storage densities between the two may be on the order of 1,000. Therefore, it may be possible to store 1,000 times more methanol than CO and H₂ within a given storage volume. In addition, it may be possible to store the same amount of methanol within a storage volume which is about 1/1,000^{th} of that required for a similar amount of CO and H₂. As such, methanol may be much more easily stored within the storage tanks 92 as compared to CO and H₂. In other words, storing CO and H₂ within the storage tanks 92 may not be economically feasible in that the storage tanks 92 would require being sized exceedingly large and, therefore, would probably not be practical, from both an operational and economic standpoint. However, converting the CO and H₂ into methanol may make the prospect of storage much more feasible. Additionally, methanol is generally safe to store and transport. As such, methanol may be used as a transportation fuel as well as being transported to various off-site facilities via trucks, pipelines, and so forth.

As illustrated in FIG. 4, a portion of the CO and H₂ gas mixture, instead of being burned within the combustion chamber 18 of the gas turbine 12, may be directed into the methanol plant 90. In particular, a flow control valve 94 may control the distribution of the CO and H₂ gas mixture into the methanol plant 90. Once in the methanol plant 90, the CO and H₂ gas mixture may be converted into methanol and may, subsequently, be stored in the storage tanks 92. At least some of the methanol stored in the storage tanks may then be utilized by a peaking cycle gas turbine 96 to drive a peak load 98 (e.g., an electrical generator). The peaking cycle gas turbine 96 may include a turbine 100, a combustor or combustion chamber 102, and a compressor 104. Therefore, at least some of the methanol stored in the storage tanks 92 may be used as a fuel source, which may be burned within the combustion chamber 102 of the peaking cycle gas turbine 96. The peaking cycle gas turbine 96 may be capable of generating power during peak load periods.

For example, the loads 14 and 98 may include electrical generators, which generate electricity for a facility, an electrical power grid, equipment, or a combination thereof. The gas turbine 12 may drive the load 14 (e.g., electrical generator) during periods of low, medium, and high demand, while the gas turbine 96 may drive the load 98 (e.g., electrical generator) during periods of high demand to provide supplemental power. The methanol plant 90 and storage tanks 92 facilitate dense fuel storage (e.g., methanol) of excess gas fuel produced by the gasifier 64 and the gas cleanup tower 72, but not used by the gas turbine 12 or other systems.

As such, during daily operation, the gasifier 64 may be run at constant conditions. However, using the present embodiments, the gasifier 64 and associated gasification process 88 may also be capable of addressing the underutilization of coal during low demand periods as well as the shortage of power during peak loading periods. Excess CO and H₂ gas mixture generated by the gasifier 64 but not necessary during low demand periods (i.e., during evenings and nights) may be sent to the methanol plant 90 for conversion into methanol and storage in the storage tanks 92. Conversely, during peak load demand periods (i.e., during mornings and afternoons), at least some of the methanol from the storage tanks 92 may be burned within the combustion chamber 102 of the peaking cycle gas turbine 96, generating supplementary power, which may be used to meet peak load power requirements. In other words, all of the gas fuel from the gasifier 64 and gas cleanup tower 72 is either used immediately by the gas turbine 12 and/or converted into methanol by the methanol plant 90 and stored in the storage tanks 92 for subsequent use as needed, for instance, by the gas turbine 96.

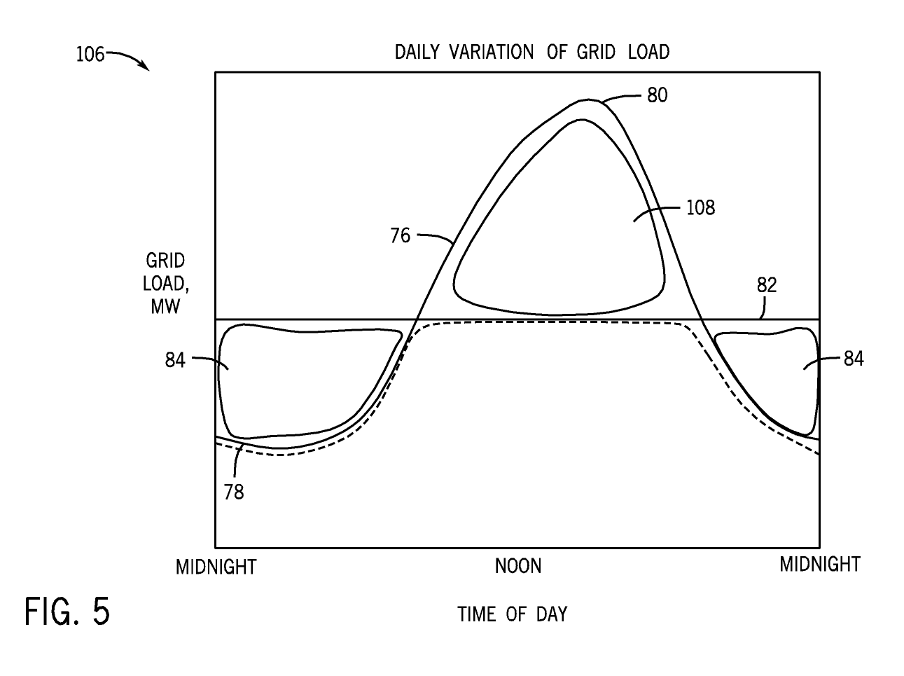

FIG. 5 is a chart 106 of daily variation of grid loads experienced by an embodiment of the coal gasification process 88 of FIG. 4. The chart 106 illustrates how the present embodiments may improve the ability of the gasification process 88 to address the grid load requirements 76. As in FIG. 3, discussed above, the grid load requirements 76 may increase from a low demand point 78, which may generally occur a few hours after midnight, to a peak load demand point 80, which may generally occur a few hours after noon. In addition, as in FIG. 3, the gasification process 88 may be operated to generate enough of the gas mixture such that the gas turbine 12 may meet the average daily load 82, which is somewhere between the low demand point 78 and the peak load demand point 80.

However, unlike in FIG. 3, the coal conversion capabilities of the gasification process 88 and, more specifically, the gasifier 64 will generally not be underutilized during low demand periods. Rather, during these low demand periods, methanol may be generated from the CO and H₂ gas mixture by the methanol plant 90 and stored in the storage tanks 92, as indicated by regions 84. In addition, during peak loading periods, at least some of the methanol stored in the storage tanks 92 may be burned within the combustion chamber 102 of the peaking cycle gas turbine 96 to generate enough supplementary power to meet peak load power requirements, as indicated by region 108. In certain embodiments, the combined cycle power generation system 10 may include a controller configured to control the combined cycle power generation system 10 such that the methanol plant 90 converts the gas mixture into methanol during periods of low demand for the gas mixture and the storage tank 92 delivers at least some of the methanol during periods of high demand for the gas mixture.

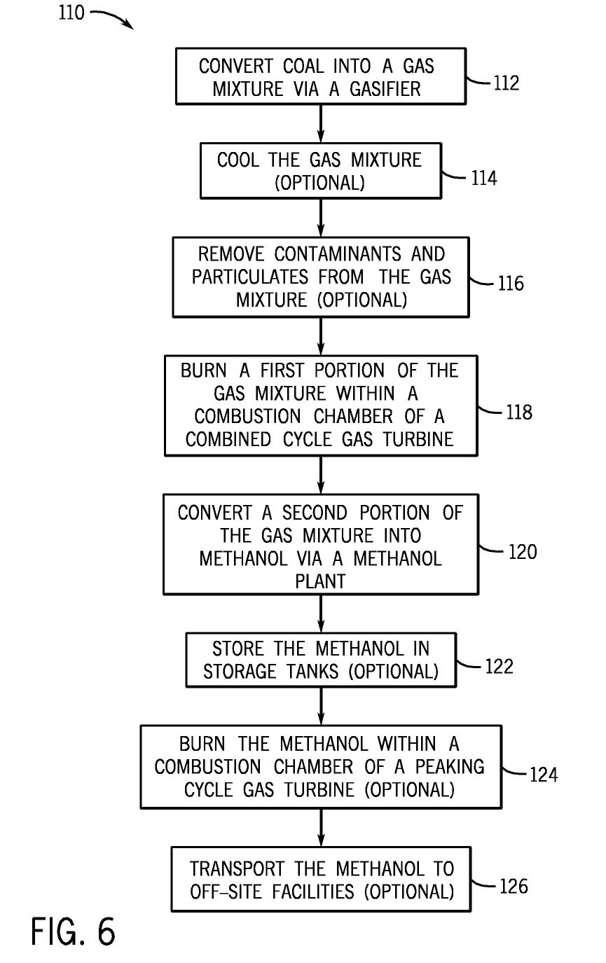

FIG. 6 is a flow chart of an embodiment of a method 110 for producing and storing methanol for use in an IGCC power generation system 10. In step 112, coal may be converted into a gas mixture via the gasifier 64. As discussed above, the coal gasification process within the gasifier 64 may break down the coal chemically with steam and high pressures and temperatures. The gas mixture may generally be composed of CO and H₂ and may be suitable as a fuel source within a combustion chamber of a gas turbine, such as the gas turbine 12 of the IGCC power generation system 10. Although presented herein as a coal gasification process, it should be noted that the process carried out within the gasifier 64 need not be limited to the conversion of coal into a gas mixture. Rather, any suitable hydrocarbon feedstock may be converted into a gas mixture within the gasifier 64. For instance, biomass and other forms of waste products and by-products may, in certain situations, be suitable for conversion into a gas mixture within the gasifier 64.

In step 114, the gas mixture may optionally be cooled. The cooling may be performed by a gas cooling unit of the gas cleanup tower 72. However, the gas cooling unit may, in certain embodiments, be a separate component from the gas cleanup tower 72. As discussed above, the extracted heat from the gas mixture may be captured and used within other processes, both within and external to the IGCC power generation system 10. For instance, the extracted heat may be directed into a stage of the HRSG 32 and ultimately transferred into steam for use in the bottoming cycle of the IGCC power generation system 10. Step 114 may generally be performed before step 116.

In step 116, contaminants and particulates may optionally be removed from the gas mixture via the gas cleanup tower 72. As discussed above, these contaminants and particulates may include sulfur and associated sulfides, such as hydrogen sulfide and carbonyl sulfide, mercury, ammonia, slag, and other particulates. Solid particulates may be removed by scrubbers and dry filtration equipment, while sulfides and so forth may be removed using solvents. Once the gas mixture has been cleaned and processed, it may be used as a fuel source by, among other things, gas turbines such as the gas turbine 12 of the IGCC power generation system 10.

Indeed, in step 118, a first portion of the gas mixture may be burned within the combustion chamber 18 of the gas turbine 12 of the IGCC power generation system 10. The gas mixture may first be split into a first portion (step 118), which may be directed toward the gas turbine 12 of the IGCC power generation system 10, and a second portion (step 120), which may be directed toward the methanol plant 90. As discussed above, the amount of gas mixture in each of these first and second portions may be controlled, at least in part, by the flow control valve 94, illustrated in FIG. 4 above. Furthermore, a control system may be configured to control the operation of the control valve 94 such that the first and second portions of the gas mixture are apportioned according to the particular needs of the IGCC power generation system 10.

For instance, during periods of low demand for the gas turbine 12 of the IGCC power generation system 10, the second portion directed toward the methanol plant 90 may be increased, such that only the amount of gas mixture required by the gas turbine 12 is directed toward the gas turbine 12. Conversely, during periods of high demand for the gas turbine 12 of the IGCC power generation system 10, the second portion directed toward the methanol plant 90 may be reduced, or even shut off, such that the gas turbine 12 receives a desired amount of the gas mixture.

In step 120, the second portion of the gas mixture may be converted into methanol by the methanol plant 90. For instance, as discussed above, the methanol plant 90 may convert the gas mixture into methanol during periods of low demand for the gas turbine 12 of the IGCC power generation system 10. In step 122, at least some of the methanol produced by the methanol plant 90 may optionally be stored within the storage tanks 92. Storing the methanol in the storage tanks 92 is facilitated by the fact that the storage density of methanol may generally be considerably higher than that of the gas mixture. As such, it may be possible to store more methanol within a given storage volume. In addition, required storage volumes may be reduced due to the higher storage density of methanol.

The methanol produced by the methanol plant 90, whether stored in the storage tanks 92 or not, may have several various uses. For example, in step 124, at least some of the methanol may optionally be burned within the combustion chamber 102 of the peaking cycle gas turbine 96. Specifically, as discussed in greater detail above, at least some of the methanol may be stored in the storage tanks 92 during periods of low demand for the gas turbine 12 of the IGCC power generation system 10. This stored methanol may then be used by the peaking cycle gas turbine 96 during periods of high demand for the gas turbine 12 of the IGCC power generation system 10. As such, the peaking cycle gas turbine 96 may function as a supplementary power source during peak load hours when the gas turbine 12 of the IGCC power generation system 10 may not be capable of generating sufficient power to meet the peak load power requirements.

However, the methanol produced by the methanol plant 90 may have various other uses within the IGCC power generation system 10. For example, in certain embodiments, at least some of the methanol stored in the storage tanks 92 may be used by the gas turbine 12 of the IGCC power generation system 10. For instance, during periods where the gas mixture is not being produced by the gasifier 64 (e.g., during periods where coal or other hydrocarbon feedstock are unavailable), the gas turbine 12 may simply use stored methanol in the storage tanks 92 as a fuel source. Furthermore, any processes (e.g., mobile power generation devices) of the IGCC power generation system 10 in which methanol may be used as a fuel source may utilize at least some of the methanol produced by the methanol plant 90. In addition, at least some of the methanol may be used as a transportation fuel by vehicles used within the IGCC power generation system 10.

However, there are also various other uses for the methanol produced by the methanol plant 90 in addition to using it as a fuel source by the combined cycle gas turbine 12, the peaking cycle gas turbine 96, or other processes of the IGCC power generation system 10. In particular, at least some of the methanol produced by the methanol plant 90 may be used by several different types of off-site facilities. In the present context, “off-site facilities” is intended to mean facilities other than those directly associated with the IGCC power generation system 10. In step 126, at least some of the methanol produced by the methanol plant 90 may optionally be transported to various off-site facilities. For example, in certain embodiments, at least some of the methanol may be transported to other simple or combined cycle power plants where the methanol may be consumed to produce additional power. In other embodiments, at least some of the methanol may be distributed to other off-site facilities for use as a transportation fuel. Indeed, the methanol may be used as an added value stream by the IGCC power generation system 10 by transporting at least some of the methanol to any off-site facilities which may utilize methanol as a fuel source.

Technical effects of the invention include providing a methanol plant 90 and associated storage tanks 92 for producing and storing methanol for use within the IGCC power generation system 10. Specifically, the gas mixture produced by the gasifier 64 may be converted into methanol, which may be stored much more cost-efficiently than the gas mixture. As such, the methanol may be produced and stored during periods of low demand for the gas turbine 12 of the IGCC power generation system 10. Then, at least some of the stored methanol may used by the peaking cycle gas turbine 96 during periods of high demand for the gas turbine 12 of the IGCC power generation system 10. In doing so, the IGCC power generation system 10 may be characterized by greater flexibility and enhanced self-sustainability. Specifically, the IGCC power generation system 10 may be better prepared to handle not only daily, but also longer-term, variations in power requirements. Moreover, this increased flexibility may also reduce the dependency of the IGCC power generation system 10 upon external sources of power, such as peaking plants.

In addition to allowing for greater flexibility and self-sustainability, by more efficiently utilizing the gas mixture produced by the gasifier 64, it may be possible to reduce the size of the gasifier 64 which may, in turn, reduce the cost of the gasifier 64. For instance, sizing the gasifier 64 for 50-70%, instead of 100%, of the peak load power requirements may allow for substantial cost reductions. In addition, the ability to run the gasifier 64 at a more constant production rate (i.e., at design operating conditions) throughout the day may eliminate the need to periodically cycle the gasifier 64, leading to an overall reduction in operating costs, as well as a reduction in long-term damage to the gasifier 64.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method, comprising:
converting a hydrocarbon feedstock into a gas mixture;
burning a first portion of the gas mixture within a combustion chamber; and
converting a second portion of the gas mixture into methanol during periods of low demand for the gas mixture within the combustion chamber.

2. The method of claim 1, comprising:
converting coal into the gas mixture via a gasifier, wherein the gas mixture comprises carbon monoxide and hydrogen;
cooling the gas mixture;
removing contaminants and particulates from the gas mixture, wherein the gas mixture is cooled before the contaminants and particulates are removed from the gas mixture;
burning the first portion of the gas mixture within a first combustion chamber of a first gas turbine of a combined cycle power generation system;
converting the second portion of the gas mixture into methanol via a methanol plant during periods of low demand for the first gas turbine of the combined cycle power generation system;
storing the methanol within a storage tank; and
burning the stored methanol within a second combustion chamber of a peaking cycle gas turbine during periods of high demand for the first gas turbine of the combined cycle power generation system.

3. The method of claim 1, comprising storing the methanol.

4. The method of claim 3, comprising burning at least some of the stored methanol to drive a load.

5. The method of claim 4, comprising burning at least some of the stored methanol to drive an electrical generator.

6. The method of claim 3, comprising burning stored methanol within a peaking cycle gas turbine during periods of high demand for the gas mixture within the combustion chamber.

7. The method of claim 1, comprising extracting heat from the gas mixture before burning the first portion of the gas mixture or converting the second portion of the gas mixture.

8. The method of claim 7, wherein heat extracted from the gas mixture is captured and used within a combined cycle power generation system.

9. The method of claim 1, comprising removing contaminants and particulates from the gas mixture before burning the first portion of the gas mixture or converting the second portion of the gas mixture.

10. The method of claim 9, wherein the gas mixture is cooled before the contaminants and particulates are removed.

11. The method of claim 3, comprising transporting at least some of the stored methanol to other gas turbines at off-site facilities for use as a fuel source.

12. The method of claim 3, comprising transporting at least some of the stored methanol off-site facilities for use as a transportation fuel.

13. A power generation system, comprising:
a gasifier configured to convert a hydrocarbon feedstock into a gas mixture;
a gas turbine configured to receive and burn a first portion of the gas mixture as a fuel source; and
a methanol plant configured to receive and convert a second portion of the gas mixture into methanol during periods of low demand for the gas turbine.

14. The system of claim 13, wherein the hydrocarbon feedstock is coal.

15. The system of claim 13, comprising a gas cleanup tower configured to remove contaminants and particulates from the gas mixture.

16. The system of claim 15, wherein the gas cleanup tower comprises a gas cooling unit configured to cool the gas mixture before removal of the contaminants and particulates.

17. The system of claim 13, comprising a storage tank configured to store at least some of the methanol produced by the methanol plant.

18. The system of claim 13, comprising a peaking cycle gas turbine configured to receive and burn at least some of the methanol produced by the methanol plant during periods of high demand for the gas turbine.

19. A methanol generation and storage system, comprising:
a methanol plant configured to receive a variable portion of a gas mixture from a gasifier and to convert the variable portion of the gas mixture into methanol; and
a storage tank configured to store the methanol and to deliver the methanol for subsequent use as a fuel source.

20. The system of claim 19, comprising a controller configured to control the methanol plant and the storage tank such that the methanol plant converts the variable portion of the gas mixture into methanol during periods of low demand for the gas mixture and the storage tank delivers the methanol during periods of high demand for the gas mixture.
